(19) United States
(12) Patent Application Publication
(10) Pub. No.: US 2015/0032622 A1
(43) Pub. Date: Jan. 29, 2015

(54) ONLINE CREDIT RETURNS METHOD AND APPARATUS

(71) Applicant: MASTERCARD INTERNATIONAL INCORPORATED, Purchase, NY (US)

(72) Inventor: Jonathan R. Powell, Rye Brook, NY (US)

(73) Assignee: MASTERCARD INTERNATIONAL INCORPORATED, Purchase, NY (US)

(21) Appl. No.: 13/953,016

(22) Filed: Jul. 29, 2013

(51) Int. Cl. G06Q 20/10; G06Q 20/40

(52) U.S. Cl. CPC G06Q 20/10; G06Q 20/40
USPC 705/44; 705/39

(57) ABSTRACT

A system, method, and computer-readable storage medium configured to enable an immediate online credit refund transaction.

### BACKGROUND

1. Field of the Disclosure

Aspects of the disclosure relate in general to financial services. Aspects include an apparatus, system, method and computer-readable storage medium to enable an immediate online credit return (refund) transaction.

2. Description of the Related Art

Sometimes, when a consumer buys a product from a merchant, the consumer might have “buyer's remorse.” In such instances, a customer will return the merchandise to the merchant and be refunded their purchase price back. Usually, the monetary value refunded is via the same mechanism as the original purchase. For example, cash purchases result in cash returns, and payment card purchases are returned to the consumer's payment card account.

Currently, while payment card purchases are instantaneously applied to a cardholder's card account balance, card returns are processed in a batch submission process. The batch process nature of the card returns results in cardholders typically waiting days for a return credit to post to their account balance in order to make the associated funds available.

As a result, cardholders near the limit of their available balance may not be able to use their card while waiting for the credit return to post. Major merchants report that cardholder inquiries on purchase returns are the single most prevalent customer service issue.

### SUMMARY

Embodiments include a system, device, method and computer-readable medium that enable an immediate online credit refund transaction.

### BRIEF DESCRIPTION OF THE DRAWINGS

FIG. 1 illustrates an embodiment of a system configured to utilize standard authorization message specifications between parties to enable an immediate online credit refund transaction.

FIG. 2 is a block diagram of a payment card network processing embodiment configured to enable an immediate online credit refund transaction.

FIG. 3 is a flowchart of an online process embodiment to enable an immediate online credit refund transaction.

FIG. 4 illustrates a flowchart of a batch clearing process method embodiment used in conjunction with the online process embodiment of FIG. 3 to support the immediate online credit refund transaction.

### DETAILED DESCRIPTION

One aspect of the disclosure includes the realization that an online process enabling an immediate online credit refund transaction would result in greater spend by cardholders, reduce the number of cardholder inquiries on purchase returns, and lead to greater satisfaction by cardholders.

In another aspect of the disclosure, the online credit refund transaction establishes controls to ensure that fraudulent returns are not submitted into the network, preventing swindlers or con artists from adding funds to accounts in their possession.

In yet another aspect of the disclosure, embodiments provide security through card network screening of the online credit return transaction to ensure it is related to a previous purchase transaction before passing the authorization on to an issuer to affect the cardholder's open to buy/available balance.

These and other benefits may be apparent in hindsight to one of ordinary skill in the art.

Embodiments of the present disclosure include a system, method, and computer-readable storage medium configured to enable an immediate online credit refund transaction.

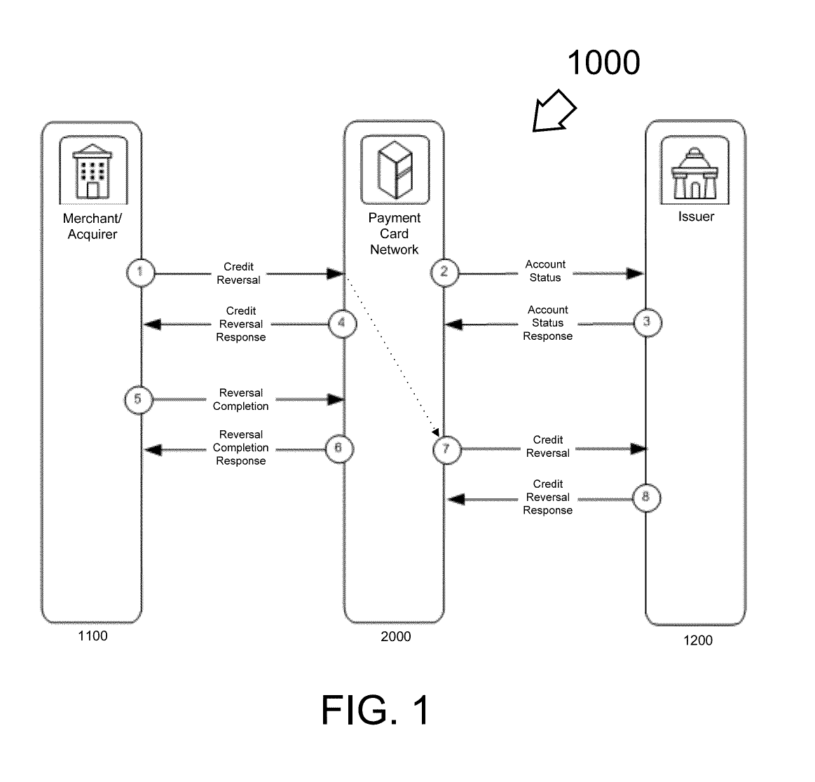

FIG. 1 illustrates an embodiment of a system 1000 configured to enable an immediate online credit refund transaction, constructed and operative in accordance with an embodiment of the present disclosure. FIG. 1 depicts three entities in an online credit return transaction, a merchant/acquirer 1100, a payment card network 2000, and an issuer 1200.

An acquirer (sometimes known as an “acquiring bank” or “merchant bank”) is the bank or other financial institution that processes card payments for products or services for a merchant. The term acquirer indicates that the bank accepts or acquires card payment from the card-issuing banks within a payment card network association. In some instances, a merchant may act as its own acquirer or perform subsets of acquiring functions, and is shown for simplicity as merchant/acquirer 1100.

A payment card network 2000 is a payment network capable of processing payments electronically. An example payment card network 2000 includes MasterCard International Incorporated of Purchase, N.Y. Payment card networks may support multiple merchant/acquirers 1100 and issuers 1200, or single merchant/acquiring and/or issuing entities.

An issuer 1200 (also known as an “issuing bank”) is a bank or other type of financial institution that offers payment card network-branded payment cards directly to consumers (also known as “cardholders”). In a typical purchase transaction, issuer 1200 issues payment to the merchant/acquirer 1100 on behalf of its cardholder (the purchaser).

It is understood by those familiar with the art that communication between merchant/acquirer 1100, payment card network 2000, and issuer 1200 is via an interbank network (not shown), a secure data network connecting financial institutions. In alternate embodiments, merchant/acquirer 1100, payment card network 2000, and issuer 1200 may communicate via any computer data network known in the art, such as a Wide Area Network (WAN), including the Internet.

An online credit reversal authorization flow embodiment is depicted in FIG. 1. In such an online credit reversal authorization flow, the customer/cardholder has returned a purchase to a merchant, and the merchant is initiating the credit return transaction through its merchant/acquirer 1100. FIG. 1 illustrates an example online credit reversal authorization message flow

At block 1, as a response to the customer (cardholder) return, the merchant/acquirer 1100 initiates an Authorization Request/Credit Reversal message and sends the message to the payment card network 2000.

In order to properly reply to the Authorization Request/Credit Reversal message, the payment card network 2000 first holds the Credit Reversal and generates a separate Authorization Request/Account Status message and sends it to the issuer 1200, block 2.

At block 3, the issuer 1200 responds to the Authorization Request/Account Status message by generating an appropriate Authorization Request Response/Status Response message to the Account Status message and sends it to the payment card network 2000.

The payment card network 2000 then replies to the original Authorization Request/Credit Reversal message it received from the acquirer at block 1 with an Authorization Request Response/Credit Reversal Response message based on the issuer response to the Account Status message, block 4.

If the credit return is completed at the merchant with a credit to the customer's card account, the merchant/acquirer 1100 responds to the payment card network 2000 with an Authorization Advice/Reversal Completion message, block 5.

The payment card network 2000 then replies to the merchant/acquirer 1100 with an Authorization Advice Response/Completion Response message, block 6.

The payment card network 2000 then releases the original Authorization Request/Credit Reversal message it received from the merchant/acquirer at block 1 and forwards it to the issuer 1200, block 7.

The issuer 1200 generates an Authorization Request Response/Credit Reversal Response message to the Credit Reversal message and sends it to the payment card network 2000, block 8. Other variations of authorization messages could exist to allow the network to effectively “hold” the original credit reversal request while intermediary messages are exchanged in order to determine the status of the card account before proceeding.

These messages are best understood with the process embodiments described below.

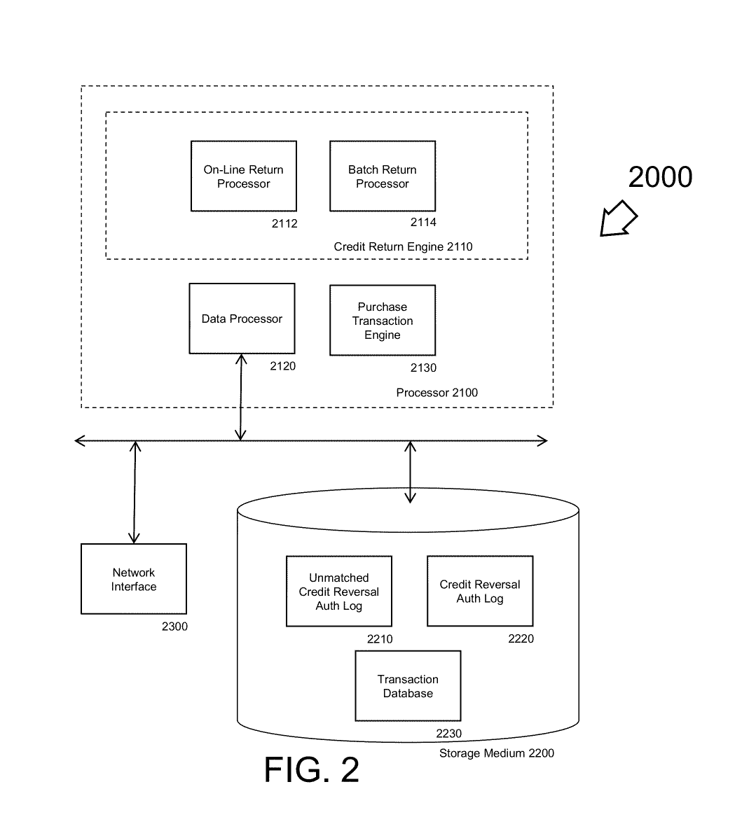

Embodiments will now be disclosed with reference to a block diagram of an exemplary payment card network server 2000 of FIG. 2, configured to enable an immediate online credit refund transaction, constructed and operative in accordance with an embodiment of the present disclosure.

Payment card network server 2000 may run a multi-tasking operating system (OS) and include at least one processor or central processing unit (CPU) 2100, a non-transitory computer-readable storage medium 2200, and a network interface 2300.

Processor 2100 may be any central processing unit, microprocessor, micro-controller, computational device or circuit known in the art.

As shown in FIG. 2, processor 2100 is functionally comprised of a credit return engine 2110, a purchase transaction engine 2130, and a data processor 2120.

Data processor 2120 interfaces with storage media 2200 and network interface 2300. The data processor 2120 enables processor 2100 to locate data on, read data from, and writes data to, these components.

Purchase transaction engine 2130 processes purchase transactions, and may do so in conjunction with credit return engine 2110.

Credit return engine 2110 is the structure that enables an on-line credit refund transaction, and may further comprise: an on-line return processor 2112 and a batch return processor 2114.

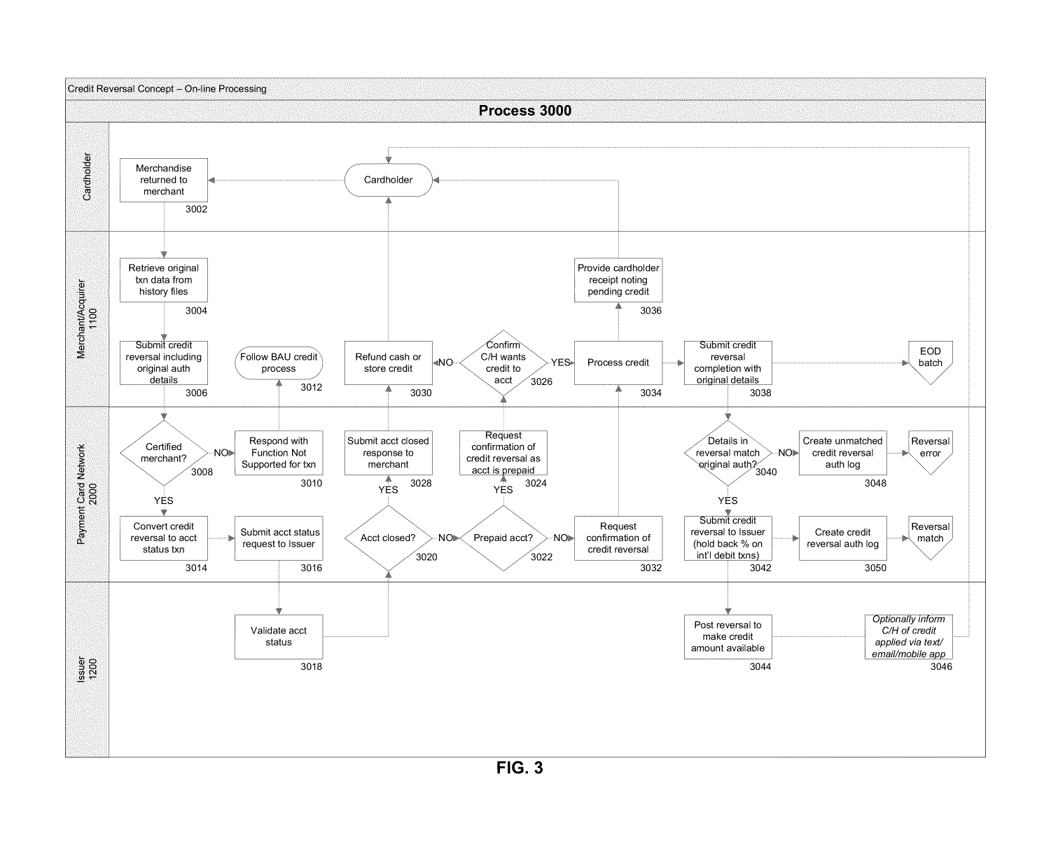

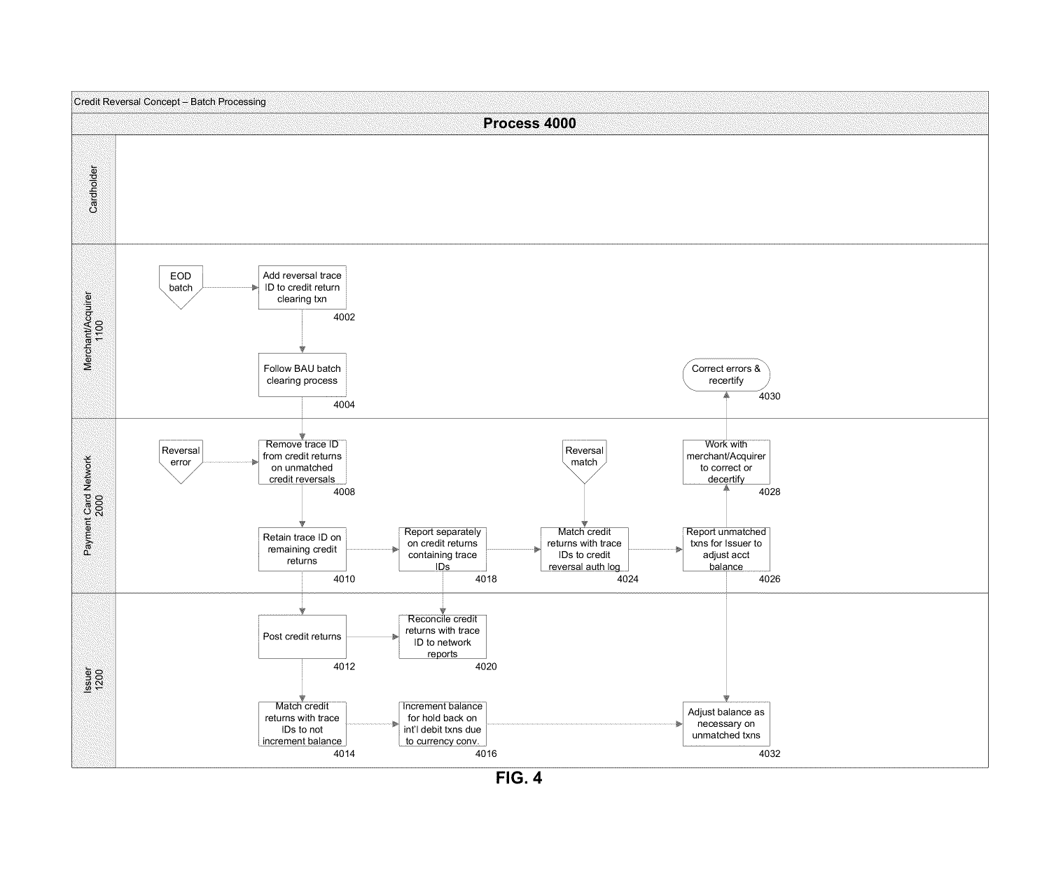

On-line return processor 2112 processes on-line credit refund transactions, while batch return processor 2114 performs a back-end batch process to facilitate the on-line credit refund transaction. The functionality of both structures is elaborated in greater detail in FIGS. 3 and 4.

Credit return engine 2110 may store data related to payment credit, debit, or charge information in a transaction database 2230.

These structures may be implemented as hardware, firmware, or software encoded on a computer readable medium, such as storage media 2200. Further details of these components are described with their relation to method embodiments below.

Computer-readable storage media 2200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. In some embodiments, computer-readable storage media 2200 may be remotely located from processor 2100, and be connected to processor 2100 via a network such as a local area network (LAN), a wide area network (WAN), or the Internet.

In addition, as shown in FIG. 2, storage media 2200 may also contain an Unmatched Credit Reversal Authorization Log database 2210, a Credit Reversal Authorization Log database 2220, and a transaction database 2230. It is understood by those familiar with the art that one or more of these databases 2210-2230 may be combined in a myriad of combinations.

Network interface 2300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2300 allows payment card network server 2000 to communicate with merchant/acquirer 1100 and issuer 1200.

We now turn our attention to method or process embodiments of the present disclosure, FIGS. 3-4. It is understood by those known in the art that instructions for such method embodiments may be stored on their respective computer-readable memory and executed by their respective processors. It is understood by those skilled in the art that other equivalent implementations can exist without departing from the spirit or claims of the invention.

FIGS. 3 and 4 flowchart method embodiments enabling an immediate online credit refund transaction, constructed and operative in accordance with an embodiment of the present disclosure. FIG. 3 illustrates an online process 3000, while FIG. 4 illustrates a corresponding supporting batch process 4000. These methods illustrate example functionality behind the message flows of FIG. 1 described above. In alternate embodiments, it is understood that a merchant may act as its own acquirer or perform subsets of acquiring functions, and is shown for simplicity in FIGS. 3 and 4 as merchant/acquirer 1100.

FIG. 3 illustrates process 3000 executed by merchant/acquirer 1100, payment card network 2000, and issuer 1200, constructed and operative in accordance with an embodiment of the present disclosure. Initially at block 3002, a cardholder returns merchandise to a merchant, triggering off process 3000.

The merchant/acquirer 1100 retrieves the original purchase transaction data from a transaction history database, block 3004, and submits a credit reversal message including the primary account number used for the original transaction, and the original authorization details from the transaction history database, block 3006. Embodiments may retrieve the original purchase transaction data based on a transaction identifier encoded on a receipt, for example. In some embodiments, the credit reversal message may correspond to the Authorization Request/Credit Reversal message of block 1 in FIG. 1.

At decision block 3008, the on-line return processor 2112 of payment card network 2000 determines whether the merchant was certified to send a credit reversal transaction request. If not certified, the payment card network 2000 responds that that the online credit reversal process is not supported for the refund transaction, block 3010, and a conventional (“business as usual,” or “BAU”) return process is used, block 3012.

If the merchant is certified, the payment card network converts the credit reversal message into an account status transaction, block 3014, to verify that the account is active and in good standing. In doing so, the payment card network 2000 is attempting to determine the current status of the Primary Account Number associated with the original transaction. The account status message is sent to the issuer 1200, at block 3016. In some instances, the account status message may correspond to an Authorization Request/Account Status message to the issuer 1200 of block 2 in FIG. 1.

The issuer 1200 validates the status of the cardholder account, at block 3018, by generating an appropriate status response message, i.e. whether the account is valid, and the type of account. For example, one response message may be that the account is a closed pre-paid account. In another example, a response message may be that the account is an open credit-card account in good standing. In some embodiments, the status response message is an Authorization Request Response/Status Response message, as described at block 3 in FIG. 1.

At block 3020, the payment card network 2000 interprets the status response message to determine whether the corresponding Primary Account Number is an open account, or a closed account.

If the Primary Account Number associated with the transaction is closed, as determined at decision block 3020, the merchant/acquirer 1100 is informed of the closure, at block 3028. In some embodiments, the confirmation is an Authorization Request Response/Credit Reversal Response message based on the issuer response to the Account Status message, block 4 in FIG. 1.

If the account is closed, at block 3030, the merchant/acquirer 1100 refunds cash or store credit to the cardholder, and the process ends.

If the account associated with the transaction remains open, as determined at decision block 3020, payment card network 2000 interprets the status response message to determine whether the account used was a prepaid account, block 3022.

If the account was a prepaid account, as determined by the status response message at block 3022, the payment card network 2000 requests a confirmation of the credit reversal of the prepaid account from the merchant/acquirer 1100 at block 3024. In some embodiments, the confirmation is an Authorization Request Response/Credit Reversal Response message based on the issuer response to the Account Status message, block 4 in FIG. 1.

At block 3026, merchant/acquirer 1100 confirms whether the cardholder wishes credit returned to the account. If no credit is desired, the process flow continues at block 3030. If credit is desired, the process continues at block 3034.

If the account was not a prepaid account, as determined at block 3022, the payment card network 2000 requests a confirmation of the credit reversal from the merchant/acquirer 1100, block 3032. In some embodiments, the confirmation is an Authorization Request Response/Credit Reversal Response message based on the issuer response to the Account Status message, block 4 in FIG. 1.

At block 3034, the merchant/acquirer 1100 processes the credit. The cardholder is also provided a receipt noting the pending credit, block 3036. With the credit completed by the merchant/acquirer 1100, at block 3038, the merchant/acquirer 1100 submits a credit reversal completion message with the original details of the transaction. In some embodiments, the credit reversal completion message is an Authorization Advice/Reversal Completion message, block 5 in FIG. 1. The process 3000 continues at block 3040, and with the end of day (EOD) batch processing shown in FIG. 4.

At block 3040, payment card network 2000 receives the credit reversal completion message and replies to the merchant/acquirer 1100 with an Authorization Advice Response/Completion Response message, block 6 in FIG. 1, and then compares the details of the credit reversal with the original authorization in transaction database 2230. In some embodiments, the comparison may include the original transaction details provided by the merchant against transaction details stored by the network in transaction database 2230, such as the Primary Account Number, the total amount of the transaction, items purchased, and prices of the items purchased. If the details do not match, the on-line return processor 2112 creates an unmatched credit reversal authorization log database 2210, block 3048 and the process continues with the Reversal error processing in FIG. 4. If certain credit reversal details match the original authorization details or are otherwise accepted, as determined at block 3040, payment card network 2000 submits a credit reversal to issuer 1200. In some embodiments, the credit reversal message may be a release of the original Authorization Request/Credit Reversal message forwarded to the issuer 1200, block 7 in FIG. 1. In yet some other embodiments, the credit reversal subtracts a holdback percentage on international debit transactions. The process continues with block 3050 to create a credit reversal authorization log database 2220, and at block 3044.

At block 3044, the issuer 1200 posts the credit reversal to make the credit amount available to the cardholder. In some embodiments, the card holder may be informed about the credit refund via SMS text messaging, electronic mail, or via a mobile application running on a mobile phone or tablet computer embodiment, at block 3046.

In other embodiments, the issuer 1200 may generate an Authorization Request Response/Credit Reversal Response message to the Credit Reversal message to the payment card network 2000, block 8 in FIG. 1.

FIG. 4 illustrates a flowchart of the unique processing of on-line credit returns in a typical payment card network batch clearing process 4000 embodiment used in conjunction with the online process 3000 embodiment of FIG. 3 to support the immediate online credit refund transaction.

At merchant/acquirer 1100, an “end of day” batch process adds the authorization network trace identifier from the Authorization Request Response/Reversal Response message from block 4 in FIG. 1 to a card return clearing transaction, block 4002. Merchant/acquirer 1100 then follows the conventional BAU batch clearing process, block 4004. The process continues at the payment card network 2000, at block 4008.

At the payment card network 2000, when an unmatched credit reversal authorization log database 2210 was created, block 3048, the authorization network trace identifier is removed from unmatched credit return clearing transactions in block 4008.

However, the authorization network trace identifier is retained on remaining credit return clearing transactions, block 4010, and the information is sent to the issuer 1200 as part of the typical batch clearing process. The process flow continues at the issuer 1200 at block 4012, and at the payment card network 2000 at block 4018.

At block 4018, the payment card network 2000 reports separately on credit return clearing transactions containing authorization network trace identifiers. The process flow continues at the issuer 1200 at block 4020, and at the payment card network 2000 at block 4024.

The payment card network 2000 uses the credit reversal authorization log database 2220 created in block 3050 with block 4024.

At block 4024, the payment card network 2000 attempts to match credit return clearing transactions with authorization network trace identifiers to the credit reversal authorization log database 2220. Any unmatched transactions are reported to the issuer 1200 to provide notification that an account balance may need to be adjusted, block 4026, and the process 4000 continues with the payment card network 2000 at block 4028, and the issuer 2000 at block 4032.

At block 4028, the payment card network 2000 works with the merchant/acquirer 1100 to correct or decertify merchants not providing accurate credit reversal transaction data in the on-line or batch processing functions. The merchant/acquirer 1100 follows up to correct errors and recertify merchants, at block 4030.

A portion of the batch processing occurs at issuer 1200.

At block 4012, issuer 1200 receives the credit return clearing transactions from the payment card network 2000, which allows it to post credit returns, block 4012, and reconcile credit returns with authorization network trace identifiers to network reports, block 4020.

At block 4014, the credit returns with authorization network trace identifiers are matched to the previous Authorization Request/Credit Reversal message, block 7 in FIG. 1, to not increment the account balances further as the credits were already applied to the available balance during the on-line process, block 3044.

At block 4016, the cardholder's balance is incremented for hold back on international debit transactions due to currency conversions.

Finally, the account balance can be adjusted on any unmatched transactions if needed, block 4032, and the process ends.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. An online return payment card network method comprising:
receiving from a merchant or acquirer, via a network interface, a credit reversal message, the credit reversal message containing an account number for the reversal transaction and original purchase transaction details with a merchant;
verifying, with an issuer of an account associated with the account number via the network interface, that the account is in good standing;
comparing, with a processor, certain details in the credit reversal message and the original purchase transaction details stored by the payment card network;
sending, via the network interface, a credit reversal to the issuer when certain details in the credit reversal message and the payment card network's original purchase transaction details match or are otherwise accepted.

2. The method of claim 1 wherein the original purchase transaction details includes an account number for the purchase transaction.

3. The method of claim 2 wherein the comparing includes matching the account number for the purchase transaction with the account number for the reversal transaction.

4. The method of claim 1 wherein the original purchase transaction details include a list of services or products purchased.

5. The method of claim 4 wherein the credit reversal message further includes a list of services or products returned.

6. The method of claim 5 wherein the comparing includes matching the list of services or products purchased against the list of services or products returned.

7. A payment card network apparatus comprising:
a network interface configured to receive a credit reversal message, the credit reversal message containing an account number for the reversal transaction and original purchase transaction details with a merchant, and configured to verify with an issuer of an account associated with the account number via the network interface, that the account is in good standing;
a microprocessor configured to compare certain details in the credit reversal message and the original purchase transaction details stored by the payment card network;
wherein the network interface is further configured to send a credit reversal to the issuer when certain details of the credit reversal message and the payment card network's original purchase transaction details match or are otherwise accepted.

8. The apparatus of claim 7 wherein the original purchase transaction details includes an account number for the purchase transaction.

9. The apparatus of claim 8 wherein the comparing includes matching the account number for the purchase transaction with the account number for the reversal transaction.

10. The apparatus of claim 7 wherein the original purchase transaction details include a list of services or products purchased.

11. The apparatus of claim 10 wherein the credit reversal message further includes a list of services or products returned.

12. The apparatus of claim 11 wherein the comparing includes matching the list of services or products purchased against the list of services or products returned.

13. A non-transitory computer-readable storage medium encoded with data and instructions, when executed by a computing device the instructions causing the computing device to:
receive from a merchant or acquirer, via a network interface, a credit reversal message, the credit reversal message containing an account number for the reversal transaction and original purchase transaction details with a merchant;
verify, with an issuer of an account associated with the account number via the network interface, that the account is in good standing;
compare, with a processor, certain details in the credit reversal message and the original purchase transaction details stored by the payment card network;
send, via the network interface, a credit reversal to the issuer when certain details of the credit reversal message and the payment card network's original purchase transaction details match or are otherwise accepted.

14. The non-transitory computer-readable storage medium of claim 13 wherein the original purchase transaction details includes an account number for the purchase transaction.

15. The non-transitory computer-readable storage medium of claim 14 wherein the comparing includes matching the account number for the purchase transaction with the account number for the reversal transaction.

16. The non-transitory computer-readable storage medium of claim 13 wherein the original purchase transaction details include a list of services or products purchased.

17. The non-transitory computer-readable storage medium of claim 16 wherein the credit reversal message further includes a list of services or products returned.

18. The non-transitory computer-readable storage medium of claim 17 wherein the comparing includes matching the list of services or products purchased against the list of services or products returned.

19. The method of claim 1 further comprising:
verifying the merchant is certified to submit the credit reversal message before proceeding.

20. The method of claim 1 further comprising:
informing the merchant or acquirer, via the network interface, a type of account in order to determine if the credit reversal should be applied to the account number.

21. The method of claim 1 further comprising:
comparing a reversal authorization amount to an original transaction amount to ensure the credit reversal does not exceed the original transaction amount.

22. The method of claim 1 further comprising:
removing an authorization network trace identifier from reversal clearing records when the reversal authorization message does not match the original purchase transaction details.

23. The method of claim 1 further comprising:
notifying the issuer when reversal clearing records with authorization network trace identifiers do not have corresponding reversal authorization messages.

24. The method of claim 1 further comprising:
converting an initial reversal authorization message from a merchant to an account status message to an issuer.
